(19) United States
(12) Patent Application Publication
(10) Pub. No.: US 2017/0256935 A1
(43) Pub. Date: Sep. 7, 2017

(54) SYSTEM RESET FOR A PORTABLE APPARATUS

(71) Applicant: Microsoft Technology Licensing, LLC, Redmond, WA (US)

(72) Inventors: Mika Hurula, Salo (FI); Kimmo Samuel Valo, Turku (FI); Tommi Sermi, Turku (FI)

(21) Appl. No.: 15/063,463

(22) Filed: Mar. 7, 2016

(51) Int. Cl. H02H 7/18; H02H 3/06

(52) U.S. Cl. CPC H02H 7/18; H02H 3/06

(57) ABSTRACT

In one example, a portable apparatus comprises a battery and a battery protection unit. The battery protection unit comprises a switch and a fault protection module that is configured to disconnect the battery with the switch in response to a detected system fault involving the battery. The battery protection unit further comprises a reset module that is configured to disconnect the battery with the switch for a reset time period in response to a received system reset trigger signal.

### BACKGROUND

Various portable electronic devices, including mobile communication devices typically allow the user to reset the device e.g. in fault situations. In such cases, a reset signal is generated by one or more triggering events, such as a two button (e.g. volume down and power) reset in smartphones. However, one or more of these buttons may become defective, the operating system controlling the reset buttons may become unresponsive, and the battery may be non-removable. As a result, there may be instances when an alternative way to reset the device is required.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one example, a portable apparatus comprises a battery and a battery protection unit. The battery protection unit comprises a switch and a fault protection module that is configured to disconnect the battery with the switch in response to a detected system fault involving the battery. The battery protection unit further comprises a reset module that is configured to disconnect the battery with the switch for a reset time period in response to a received system reset trigger signal.

In another example, a battery protection unit and a method have been discussed along with the features of the portable apparatus.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example block diagram of a portable apparatus in accordance with an example embodiment;

FIG. 2 is an example block diagram of a portable apparatus in accordance with an example embodiment;

FIG. 3 is an example flow diagram of a method in accordance with an example embodiment;

FIG. 4 is an example circuit diagram in accordance with an example embodiment;

FIG. 5 illustrates an example block diagram of an electronic device capable of implementing example embodiments described herein; and

FIGS. 6A, 6B and 6C illustrate timer operation in accordance with example embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

At least some of the disclosed examples may allow a portable electronic device to be reset under any circumstances, and particularly when the device has become unresponsive due to various reasons, such as due to one or more of the buttons (e.g. volume down and power) used for a software reset becoming defective and due to the battery being non-removable.

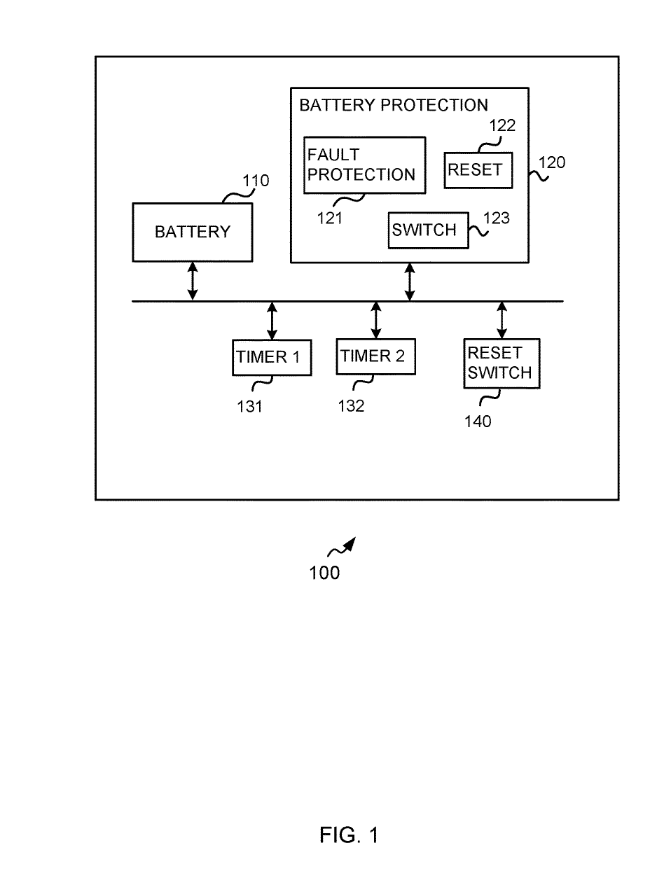

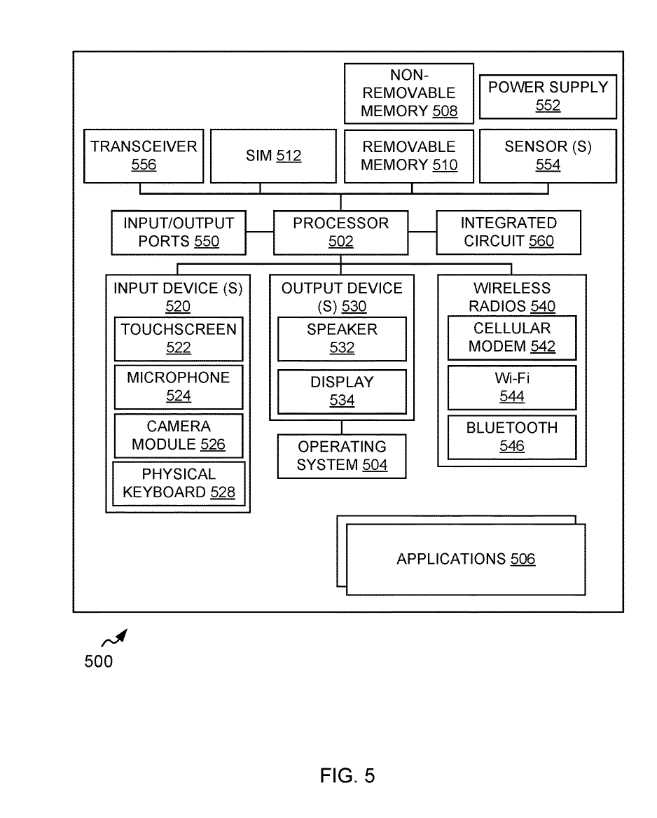

FIG. 1 illustrates an apparatus 100 in accordance with an example embodiment. The portable apparatus 100 may be employed, for example, in the electronic device 500 of FIG. 5. However, it should be noted that the portable apparatus 100 may also be employed on a variety of other devices and apparatuses, and therefore, embodiments should not be limited to application on devices and apparatuses such as the electronic device 500 of FIG. 5. Furthermore, it should be noted that at least some of the elements described below may not be mandatory and thus some may be omitted in certain embodiments.

The portable apparatus 100 comprises a battery 110 and a battery protection unit 120. The battery protection unit 120 may comprise an integrated circuit such as a battery protection circuit (also known as a battery protection IC (integrated circuit)). The battery 110 may comprise one or more battery cells. The battery cells may comprise e.g. Lithium-ion battery cells. However, it is to be understood that any other suitable types of battery cells may be used. The battery 110 may be non-removable or fixed. That is, it may not be removed from the apparatus 100 by the end user.

The battery protection unit 120 comprises a switch 123. The switch 123 may be arranged in series with the battery 110. The switch 123 may comprise e.g. a field-effect transistor (FET). However, it is to be understood that any other suitable electronic switch may be used.

The battery protection unit 120 comprises a fault protection module 121 that is configured to disconnect the battery 110 utilizing the switch 123 in response to a detected system fault involving the battery 110. Typically, the fault protection module 121 is configured to disconnect the battery 110 automatically, i.e. without user interaction. Such system fault involving the battery 110 may include but are not limited to overcurrent, overheating and overcharging of the battery 110.

The battery protection unit 120 further comprises a reset module 122 that is configured to disconnect the battery 110 utilizing the switch 123 for a reset time period in response to a received system reset trigger signal. The reset module 122 is further configured to reconnect the battery 110 utilizing the switch 123 after the reset time period has expired. In other words, the reset module 122 may be utilized to perform a system reset on the portable apparatus 100.

In the embodiment shown in FIG. 1, the portable apparatus 100 further comprises a reset switch 140, and the system reset trigger signal is sent in response to a user interaction. The user interaction comprises the user operating the reset switch. For example, when the reset switch 140 is part of a push-button or the like, the user interaction comprises the user pushing or pressing the button. Such a push-button may be a dedicated reset button not used for any other functions, and it may be at least partially hidden so that accidental button presses can be avoided. Furthermore, the reset switch 140 may be configured to bypass the operating system of the portable apparatus 100 when sending the system reset trigger signal to the battery protection unit 120 so as to avoid issues caused by an unresponsive operating system in a fault situation.

The end of the reset time period may be directly determined by the end of the user interaction. For example, if the user presses the dedicated reset button or otherwise operates the reset switch 140 for two seconds and then releases it, the reset time period may end after two seconds.

Alternatively, the end or length of the reset time period may be determined by a timer. More specifically, the portable apparatus 100 may further comprise a second timer 132, wherein the length of the reset time period is determined by the second timer 132. Here, when the user presses the dedicated reset button or otherwise operates the reset switch 140, it triggers the start of the reset time period. The end of the reset time period is determined by the second timer 132. For example, if the second timer 132 is configured for a five second reset time period, the battery 100 disconnection takes place for five seconds starting from the user operating the reset switch 140.

It is to be understood that the above discussed examples of the reset time periods do not include a debounce time period which will be discussed next.

In response to receiving the system reset trigger signal, rather than start the reset procedure immediately, the reset module 122 may be further configured to first wait until a predetermined debounce time period expires, and only then to disconnect the battery 110 in response to the system reset trigger signal still being received. The length of the debounce time period may be e.g. in the range of 0.1 seconds. In other embodiments, the length of the debounce time period may be longer, for instance 15 seconds. In such an embodiment, the portable apparatus 100 further comprises a first timer 131 that is configured to determine the length of the debounce time period.

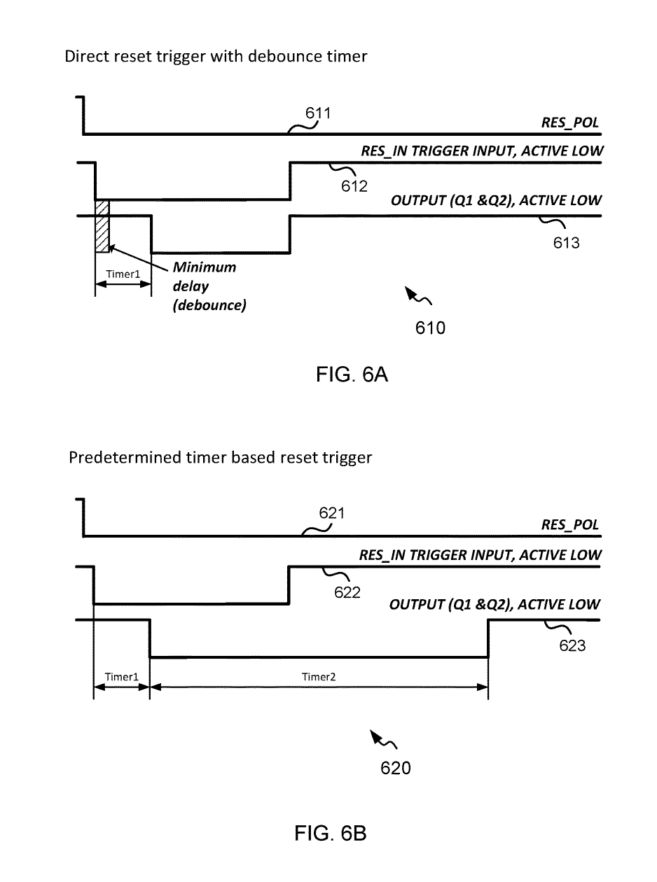

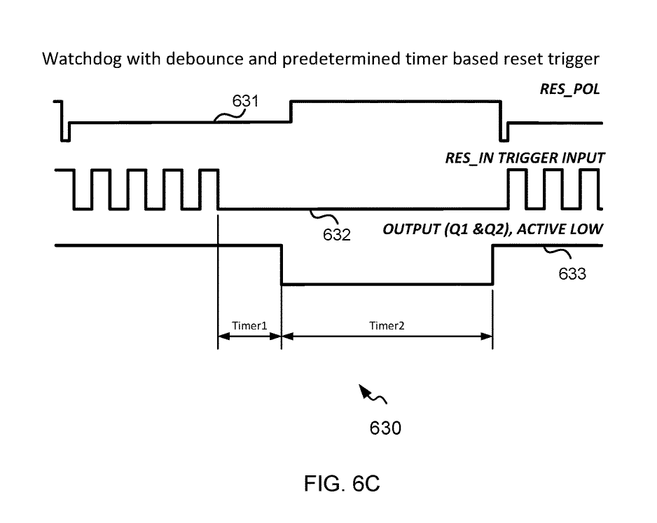

The above discussed time periods are further illustrated in FIGS. 6A and 6B.

The reset module 122 may be further configured to determine whether the system reset trigger signal is active high or active low based on a received reset polarity signal. Again, this will be further illustrated in FIGS. 6A and 6B.

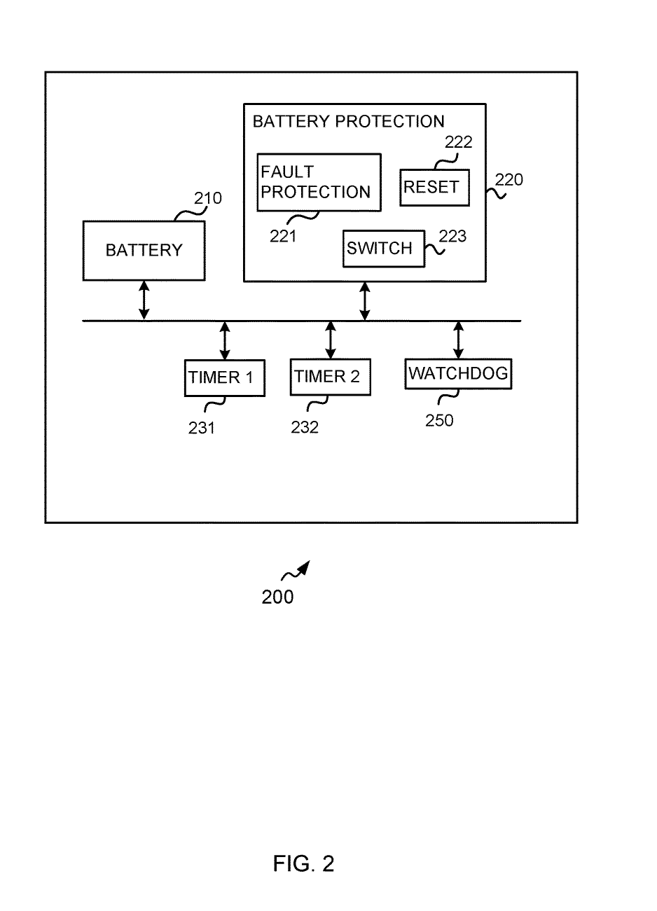

FIG. 2 illustrates a portable apparatus 200 in accordance with an example embodiment. The portable apparatus 200 may be employed, for example, in the electronic device 500 of FIG. 5. However, it should be noted that the portable apparatus 200 may also be employed on a variety of other devices and apparatuses, and therefore, embodiments should not be limited to application on devices and apparatuses such as the electronic device 500 of FIG. 5. Furthermore, it should be noted that at least some of the elements described below may not be mandatory and thus some may be omitted in certain embodiments.

In the example of FIG. 2, the functionalities and properties of the battery 210, the battery protection unit 220, the fault protection module 221, the reset module 222, the switch 223, the first timer 231, and the second timer 232 are substantially similar to those of their counterparts in the example of FIG. 1, so their descriptions are not repeated here in detail.

The example of FIG. 2 further comprises a watchdog (sometimes called a watchdog timer) module 250 that is configured to send the system reset trigger signal in response to not being restarted within a predetermined update time period. That is, rather than requiring the user interaction of the embodiment of FIG. 1, the embodiment of FIG. 2 may operate automatically, i.e. without the need for user interaction. During normal operation, the portable apparatus 200 may regularly restart the watchdog module 250 to prevent it from elapsing or timing out. If the portable apparatus 200 fails to restart the watchdog module 250, it will elapse and generate and send the system reset trigger signal to the reset module 122. The restart of the watchdog module 250 may be initiated by the system (e.g. the operating system) of the portable apparatus 200 or by e.g. a component included in a battery pack that also includes the battery 210, and the battery protection unit 220.

The watchdog module 250 may comprise software and/or hardware. For example, the watchdog module 250 may be included at least partially in an operating system of the apparatus 200, such as operating system 504 of FIG. 5. In an embodiment, the watchdog module 250 may be included at least partially in application software of the apparatus 200, such as applications 506 of FIG. 5.

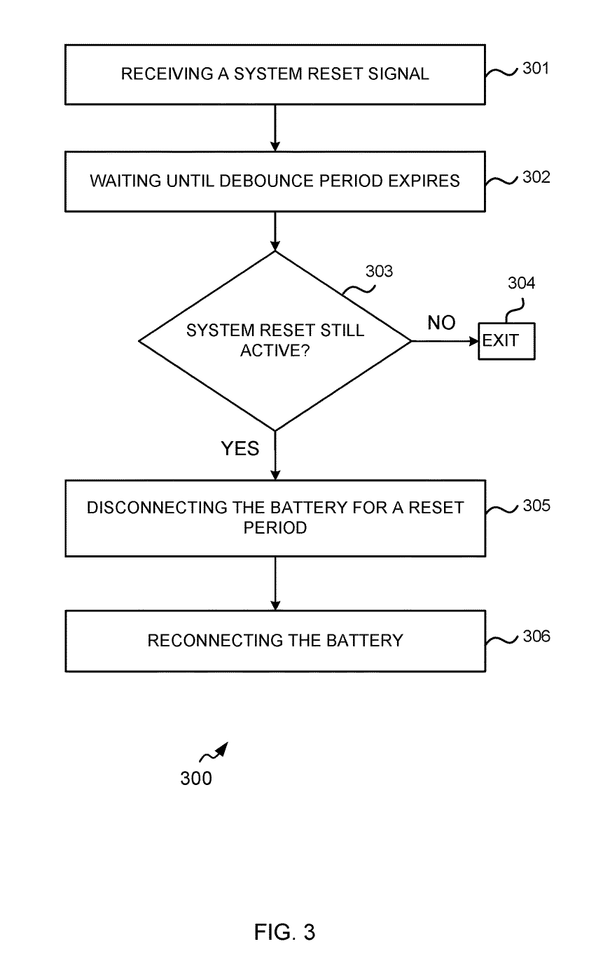

FIG. 3 is an example flow diagram of a method 300 in accordance with an example embodiment. At operation 301, a system reset trigger signal is received at a battery protection unit. At operation 302, the method 300 waits until a predetermined debounce time period expires. The length of the debounce time period may be determined by a first timer.

At operation 303, the method 300 determines whether the system reset trigger signal is still being received at the expiry of the debounce time period. If not, the method exits, operation 304. If yes, the method proceeds to disconnect the battery for a reset time period, operation 305. As discussed above, the length of the reset time period may be directly determined by the duration of a user interaction, such as pressing a dedicated reset button or otherwise operating a reset switch. Alternatively, the length of the reset time period may be determined by a second timer.

At operation 306, the battery is reconnected after the reset time period using the battery protection unit.

Operations 301-306 may be performed by the reset modules 122, 222 of FIGS. 1 and 2 with the assistance of timers 131-132 and 231-232, respectively. The method 300 may be triggered by the reset switch 140 of FIG. 1 or the watchdog module 250 of FIG. 2.

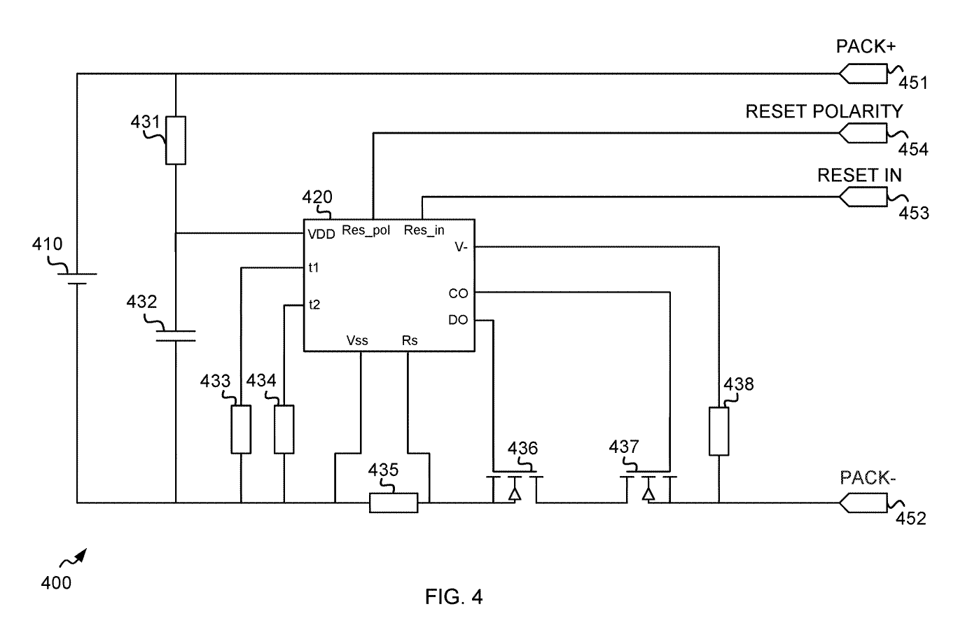

FIG. 4 is a circuit diagram in accordance with an example embodiment. The embodiment of FIG. 4 comprises a battery protection circuit 420. The battery protection circuit 420 may correspond to the battery protection unit 120 of FIG. 1 and/or battery protection unit 220 of FIG. 2.

Input t1 is for the first timer, such as the first timer 131 of FIG. 1 and/or the first timer 231 of FIG. 2. The first timer is programmable with a resistor 433. That is, the resistance value of the resistor 433 is used to select a timer value for the first timer. Similarly, input t2 is for the second timer, such as the second timer 132 of FIG. 1 and/or the second timer 232 of FIG. 2. The second timer is programmable with a resistor 434. That is, the resistance value of the resistor 434 is used to select a timer value for the second timer. If a timer value of 0 seconds is selected for the second timer, the second timer is disabled. Accordingly, this may be used for selecting between a direct reset trigger (such as the one illustrated in FIG. 6A) and a timer based reset trigger (such as the one illustrated in FIG. 6B).

Resistors 433 and 434 may set voltage dividers with internal pull ups in the battery protection circuit 420. Accordingly, voltage values in addition to the resistance values may be used to select the timer values. Here, current dividers may be utilized also.

In an embodiment, the resistors 433, 434 used to select the timer values may be included in the battery protection circuit 420 rather than being external to the battery protection circuit 420.

Input Res_pol is for a reset polarity signal used to configure the system reset trigger signal to be active high or active low. The reset polarity signal is received from pin 454. Input Res_in is for receiving the system reset trigger signal from pin 453. Outputs CO and DO are drive outputs for FETs or switches 436 (Q1), 437 (Q2). FETs or switches 436, 437 may correspond to the switch 123 of FIG. 1 and/or the switch 223 of FIG. 2, and they are connected in series at low or high side of the battery/cell(s) 410, which may correspond to the battery 110 of FIG. 1 and/or the battery 210 of FIG. 2. Pins 451 and 452 are for battery (pack) output.

Furthermore, pin 453 may be used as input for the watchdog module 250 if Res_pol is set accordingly, e.g. floating. Thus, pin 453 may be a tri-state pin. Furthermore, Res_pol may be wired as a separate battery pack input pin.

Resistor 435 may be used e.g. for current sensing and overcurrent protection triggering performed by the fault protection module 121 of FIG. 1 and/or the fault protection module 221 of FIG. 2. Here, Rs represents a current detection pin. Resistor 431 and capacitor 432 may be used e.g. for voltage sensing by the fault protection module 121 of FIG. 1 and/or the fault protection module 221 of FIG. 2. Resistor 438 may be used e.g. for current limiting. Input VDD is used for positive power supply, and inputs V- and/or Vss may be used for negative power supply. Alternatively, resistor 435 may be left out, and current may be measured across switch (FET) 436 and/or switch (FET) 437.

FIG. 5 is a schematic block diagram of an electronic device 500 capable of implementing embodiments of the techniques described herein. It should be understood that the electronic device 500 as illustrated and hereinafter described is merely illustrative of one type of apparatus or an electronic device and should not be taken to limit the scope of the embodiments. As such, it should be appreciated that at least some of the components described below in connection with the electronic device 500 may be optional and thus in an example embodiment may include more, less or different components than those described in connection with the example embodiment of FIG. 5. As such, among other examples, the electronic device 500 could be any of apparatuses utilizing a battery and particularly a non-removable battery, such as wireless or mobile communication apparatuses, such as smartphones and tablet computers.

The illustrated electronic device 500 includes a controller or a processor 502 (i.e. a signal processor, microprocessor, ASIC, or other control and processing logic circuitry) for performing such tasks as signal coding, data processing, input/output processing, power control, and/or other functions. An operating system 504 controls the allocation and usage of the components of the electronic device 500 and support for one or more application programs 506. The application programs 506 can include common mobile applications, for instance, telephony applications, email applications, calendars, contact managers, web browsers, messaging applications, or any other application. As discussed above, the operating system 504 or the application programs 506 may include the watchdog module 250 of FIG. 2.

The illustrated electronic device 500 includes one or more memory components, for example, a non-removable memory 508 and/or removable memory 510. The non-removable memory 508 may include RAM, ROM, flash memory, a hard disk, or other well-known memory storage technologies. The removable memory 510 may include flash memory or smart cards. The one or more memory components may be used for storing data and/or code for running the operating system 504 and the applications 506. Example of data may include web pages, text, images, sound files, image data, video data, or other data sets to be sent to and/or received from one or more network servers or other devices via one or more wired or wireless networks. The electronic device 500 may further include a subscriber identity module (SIM) 512. The SIM 512 typically stores information elements related to a mobile subscriber. A SIM is well known in Global System for Mobile Communications (GSM) communication systems, Code Division Multiple Access (CDMA) systems, or with third-generation (3G) wireless communication protocols such as Universal Mobile Telecommunications System (UMTS), CDMA1000, wideband CDMA (WCDMA) and time division-synchronous CDMA (TD-SCDMA), or with fourth-generation (4G) wireless communication protocols such as LTE (Long-Term Evolution). The SIM 512 may comprise a virtual SIM. Furthermore, multiple SIMs may be utilized.

The electronic device 500 can support one or more input devices 520 and one or more output devices 530. Examples of the input devices 520 may include, but are not limited to, a touchscreen 522 (i.e., capable of capturing finger tap inputs, finger gesture inputs, multi-finger tap inputs, multi-finger gesture inputs, or keystroke inputs from a virtual keyboard or keypad), a microphone 524 (i.e., capable of capturing voice input), a camera module 526 (i.e., capable of capturing still picture images and/or video images) and a physical keyboard 528. Examples of the output devices 530 may include, but are not limited to a speaker 532 and a display 534. Other possible output devices (not shown) can include piezoelectric or other haptic output devices. Some devices can serve more than one input/output function. For example, the touchscreen 522 and the display 534 can be combined into a single input/output device.

In an embodiment, the electronic device 500 may comprise a wireless radio(s) 540. The wireless radio(s) 540 can support two-way communications between the processor 502 and external devices, as is well understood in the art. The wireless radio(s) 540 are shown generically and can include, for example, a cellular modem 542 for communicating at long range with the mobile communication network, a Wi-Fi radio 544 for communicating at short range with a local wireless data network or router, and/or a BLUETOOTH radio 546. The cellular modem 542 is typically configured for communication with one or more cellular networks, such as a GSM/3G/4G network for data and voice communications within a single cellular network, between cellular networks, or between the mobile device and a public switched telephone network (PSTN).

The electronic device 500 can further include one or more input/output ports 550, a power supply 552, one or more sensors 554, for example an accelerometer, a gyroscope, a compass, or an infrared proximity sensor for detecting the orientation or motion of the electronic device 500, and a transceiver 556 (for wirelessly transmitting analog or digital signals). The power supply 552 may include the batteries 110, 210, 410 of FIGS. 1-2 and 4. Furthermore, the power supply 552 may include the battery protection units 120, 220 of FIGS. 1-2 and/or the associated timers 131-132, 231-232. Alternatively, the integrated circuit 560 may include the battery protection units 120, 220 of FIGS. 1-2 and/or the associated timers 131-132, 231-232. The illustrated components are not required or all-inclusive, as any of the components shown can be deleted and other components can be added.

Computer executable instructions may be provided using any computer-readable media that is accessible by computing based devices. Computer-readable media may include, for example, computer storage media such as memory and communications media. Computer storage media, such as memory includes volatile and non-volatile, removable and non-removable media implemented in any method or technology for storage of information such as computer readable instructions, data structures, program modules or the like. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media is shown within the computing based devices it will be appreciated that the storage may be distributed or located remotely and accessed via a network or other communication link, for example by using a communication interface.

FIG. 6A illustrates timer operation in accordance with an example embodiment. More particularly, FIG. 6A illustrates a case of a direct reset trigger with a debounce timer (i.e. the first timer 131). Herein, the ‘direct reset trigger’ refers to the case in which the length of the reset time period is determined directly by the duration of end-user interaction, as discussed in connection with FIG. 1. As discussed in connection with FIG. 4, Res_pol 611 is a reset polarity signal used to configure the system reset trigger signal 612 and output signal 613 to the switches/FETs Q1 and Q2 (i.e. system reset logic) to be active high or active low. In this example, Res_pol is used to configure the system reset logic to be active low, as can be seen from FIG. 6A.

When the system reset trigger signal 612 is activated for longer than the duration Timer1 of the first timer 131 (debounce time period), the reset output 613 activates for the remaining duration of reset input (the duration of the end user operating the reset switch 140) causing the reset module 122 to disconnect the battery 110 for the reset time period (i.e. until the end user stops operating the reset switch 140). The minimum value for Timer1 shown in FIG. 6A is debounce only. The debounce time period is used to eliminate effects of potential short interferences to avoid unintentionally resetting the apparatus 100.

FIG. 6B illustrates timer operation in accordance with another example embodiment. More particularly, FIG. 6B illustrates a case of predetermined timer (i.e. second timer 132) based reset trigger. That is, here the length of the reset time period is determined by the second timer 132, as discussed in connection with FIG. 1. As discussed in connection with FIG. 4, Res_pol 621 is a reset polarity signal used to configure the system reset trigger signal 622 and output signal 623 to the switches/FETs Q1 and Q2 (i.e. system reset logic) to be active high or active low. In this example, Res_pol is used to configure the system reset logic to be active low, as can be seen from FIG. 6B.

When the system reset trigger signal 622 is activated for longer than the duration Timer1 of the first timer 131 (debounce time period), the reset output 623 activates for the duration of Timer2 setting of the second timer 132. Again, the debounce time period is used to eliminate effects of potential short interferences to avoid unintentionally resetting the apparatus 100.

FIG. 6C illustrates timer operation in accordance with another example embodiment. More particularly, FIG. 6C illustrates a case of a watchdog combined with debounce and predetermined timer (i.e. second timer 232) based reset trigger. That is, here the length of the reset time period is determined by the second timer 232, as discussed in connection with FIG. 2. As discussed in connection with FIG. 4, Res_pol 631 is a reset polarity signal used to configure the system reset trigger signal 632 and output signal 633 to the switches/FETs Q1 and Q2 (i.e. system reset logic) to be active high or active low. In this example, Res_pol is set floating to configure the system reset logic for watchdog use, as can be seen from FIG. 6C. Accordingly, when Res_pol is left floating, the pulse length of the system reset trigger signal 632 may be used to denote whether it is for watchdog restart or for actual reset input: e.g. a short pulse restarts the watchdog, and a pulse longer (either high or low) than the duration Timer1 of the first timer 231 will initiate the reset, as shown in FIG. 6C.

As a result, when the system reset trigger signal 632 is high or low for longer than the duration Timer1 of the first timer 231 (debounce time period), the reset output 633 activates for the duration of Timer2 setting of the second timer 232. Again, the debounce time period is used to eliminate effects of potential short interferences to avoid unintentionally resetting the apparatus 200. In this example, the system reset trigger signal 632 is received from the watchdog timer module 250 e.g. in response to the watchdog 250 not being restarted by the system within a predetermined update time period.

It is to be understood that while in the examples shown in FIGS. 6B and 6C the duration Timer1 is shorter than the duration Timer2, the duration Timer1 may alternatively be equal to or longer than the duration Timer2. In an example, the duration Timer1 is 15 seconds. The system reset trigger signal 622, 632 is connected parallel to a system primary reset input (e.g. a power (PWR) key button). The system primary reset is set to trigger after 10 seconds of a combined PWR and VOL− (volume down) key press, but it fails due to VOL− button key not working. When the system primary reset operation fails, this embodiment then resets the system after the duration Timer1 (15 seconds). Timer2 can be configured to run after timer1, and timer2 may be set for example to 3 seconds.

At least some of the examples disclosed in FIGS. 1-6C are able to provide an alternative way to reset a portable apparatus. The alternative way allows resetting the portable apparatus even if one or more of the buttons typically used for reset in smartphones (such as volume down and power buttons) is damaged or becomes defective. Similarly, the alternative way allows resetting the portable apparatus even if the software (such as relevant portions of the operating system) controlling the two-button reset becomes unresponsive. Similarly, the alternative way allows resetting the portable apparatus even if the battery is non-removable thus preventing system reset via removing the battery for a short while.

At least some of the examples disclosed in FIGS. 1-6C are able to provide maintaining the series resistance on the device power path as-is. Since no new switches are added for disconnecting the battery but instead switches already implemented in a battery protection unit are utilized, the series resistance is not increased on the device power path.

An embodiment of a portable apparatus comprises a battery and a battery protection unit. The battery protection unit comprises a switch and a fault protection module that is configured to disconnect the battery with the switch in response to a detected system fault involving the battery. The battery protection unit further comprises a reset module that is configured to disconnect the battery with the switch for a reset time period in response to a received system reset trigger signal.

In an embodiment, alternatively or in addition to the above described embodiments, the reset module is further configured to reconnect the battery with the switch after the reset time period.

In an embodiment, alternatively or in addition to the above described embodiments, the system reset trigger signal is sent in response to a user interaction.

In an embodiment, alternatively or in addition to the above described embodiments, the portable apparatus further comprises a reset switch, wherein the user interaction comprises the user operating the reset switch.

In an embodiment, alternatively or in addition to the above described embodiments, the end of the reset time period is determined by the end of the user interaction.

In an embodiment, alternatively or in addition to the above described embodiments, the portable apparatus further comprises a watchdog module that is configured to send the system reset trigger signal in response to not being restarted within a predetermined update time period.

In an embodiment, alternatively or in addition to the above described embodiments, in response to receiving the system reset trigger signal, the reset module is further configured to wait until a predetermined debounce time period expires, and then to disconnect the battery in response to the system reset trigger signal still being received.

In an embodiment, alternatively or in addition to the above described embodiments, the portable apparatus further comprises a first timer, wherein the length of the debounce time period is determined by the first timer.

In an embodiment, alternatively or in addition to the above described embodiments, the portable apparatus further comprises a second timer, wherein the length of the reset time period is determined by the second timer.

In an embodiment, alternatively or in addition to the above described embodiments, the switch is arranged in series with the battery.

In an embodiment, alternatively or in addition to the above described embodiments, the switch comprises a field-effect transistor.

In an embodiment, alternatively or in addition to the above described embodiments, the reset module is further configured to determine whether the system reset trigger signal is active high or active low based on a received reset polarity signal.

In an embodiment, alternatively or in addition to the above described embodiments, the battery protection unit comprises a battery protection circuit.

An embodiment of a battery protection unit comprises a switch; a fault protection module that is configured to disconnect an associated battery with the switch in response to a detected system fault involving the battery; and a reset module that is configured to disconnect the associated battery with the switch for a reset time period in response to a received system reset trigger signal.

In an embodiment, alternatively or in addition to the above described embodiments, the switch is arranged in series with the battery.

In an embodiment, alternatively or in addition to the above described embodiments, the battery protection unit further comprises a first timer, wherein the length of a debounce time period is determined by the first timer, and wherein in response to receiving the system reset trigger signal, the reset module is further configured to wait until the debounce time period expires, and then to disconnect the battery in response to the system reset trigger signal still being received.

In an embodiment, alternatively or in addition to the above described embodiments, the battery protection unit further comprises a second timer, wherein the length of the reset time period is determined by the second timer.

An embodiment of a method comprises receiving a system reset trigger signal at a battery protection unit configured to disconnect an associated battery in response to a detected system fault involving the battery; and disconnecting the battery for a reset time period with the battery protection unit.

In an embodiment, alternatively or in addition to the above described embodiments, the method further comprises, before disconnecting the battery, waiting until a predetermined debounce time period expires; determining whether the system reset trigger signal is still being received; and if yes, proceeding to disconnect the battery.

In an embodiment, alternatively or in addition to the above described embodiments, the method further comprises reconnecting the battery after the reset time period with the battery protection unit.

An embodiment of a portable apparatus comprises a battery and a battery protection unit. The battery protection unit comprises a fault protection means for disconnecting the battery in response to a detected system fault involving the battery. The battery protection unit further comprises a reset means for disconnecting the battery for a reset time period in response to a received system reset trigger signal.

The embodiments illustrated and described herein as well as embodiments not specifically described herein but within the scope of aspects of the disclosure constitute exemplary means for performing a system reset for a portable apparatus. For example, the elements illustrated in FIG. 1 to FIG. 6C constitute exemplary means for receiving a system reset trigger signal at a battery protection unit, exemplary means for disconnecting the battery for a reset time period with the battery protection unit, and exemplary means for reconnecting the battery after the reset time period with the battery protection unit, and exemplary means for waiting until a predetermined debounce time period expires before disconnecting the battery.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include mobile telephones (including smart phones), tablet computers and many other devices.

The processes described herein may be performed by software in machine readable form on a tangible storage medium e.g. in the form of a computer program comprising computer program code means adapted to perform all the steps of any of the processes described herein when the program is run on a computer and where the computer program may be embodied on a computer readable medium. Examples of tangible storage media include computer storage devices comprising computer-readable media such as disks, thumb drives, memory etc. and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims, and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

Aspects of any of the examples described above may be combined with aspects of any of the other examples described to form further examples without losing the effect sought.

The term ‘comprising’ is used herein to mean including the blocks or elements identified, but that such blocks or elements do not comprise an exclusive list, and a system, a device or an apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. A portable apparatus, comprising:
a battery; and
a battery protection unit comprising a switch and a fault protection module configured to disconnect the battery with the switch in response to a detected system fault involving the battery,
wherein the battery protection unit further comprises a reset module configured to disconnect the battery with the switch for a reset time period in response to a received system reset trigger signal.

2. The portable apparatus as claimed in claim 1, wherein the reset module is further configured to reconnect the battery with the switch after the reset time period.

3. The portable apparatus as claimed in claim 1, wherein the system reset trigger signal is sent in response to a user interaction.

4. The portable apparatus as claimed in claim 3, further comprising a reset switch, wherein the user interaction comprises the user operating the reset switch.

5. The portable apparatus as claimed in claim 3, wherein the end of the reset time period is determined by the end of the user interaction.

6. The portable apparatus as claimed in claim 1, further comprising a watchdog module configured to send the system reset trigger signal in response to not being restarted within a predetermined update time period.

7. The portable apparatus as claimed in claim 1, wherein in response to receiving the system reset trigger signal, the reset module is further configured to wait until a predetermined debounce time period expires, and then to disconnect the battery in response to the system reset trigger signal still being received.

8. The portable apparatus as claimed in claim 7, further comprising a first timer, wherein the length of the debounce time period is determined by the first timer.

9. The portable apparatus as claimed in claim 1, further comprising a second timer, wherein the length of the reset time period is determined by the second timer.

10. The portable apparatus as claimed in claim 1, wherein the switch is arranged in series with the battery.

11. The portable apparatus as claimed in claim 10, wherein the switch comprises a field-effect transistor.

12. The portable apparatus as claimed in claim 1, wherein the reset module is further configured to determine whether the system reset trigger signal is active high or active low based on a received reset polarity signal.

13. The portable apparatus as claimed in claim 1, wherein the battery protection unit comprises a battery protection circuit.

14. A battery protection unit, comprising:
a switch;
a fault protection module configured to disconnect an associated battery with the switch in response to a detected system fault involving the battery; and
a reset module configured to disconnect the associated battery with the switch for a reset time period in response to a received system reset trigger signal.

15. The battery protection unit as claimed in claim 14, wherein the switch is arranged in series with the battery.

16. The battery protection unit as claimed in claim 14, further comprising a first timer, wherein the length of a debounce time period is determined by the first timer, and wherein in response to receiving the system reset trigger signal, the reset module is further configured to wait until the debounce time period expires, and then to disconnect the battery in response to the system reset trigger signal still being received.

17. The battery protection unit as claimed in claim 14, further comprising a second timer, wherein the length of the reset time period is determined by the second timer.

18. A method, comprising:
receiving a system reset trigger signal at a battery protection unit configured to disconnect an associated battery in response to a detected system fault involving the battery; and
disconnecting the battery for a reset time period with the battery protection unit.

19. The method as claimed in claim 18, further comprising:
before disconnecting the battery, waiting until a predetermined debounce time period expires;
determining whether the system reset trigger signal is still being received; and
if yes, proceeding to disconnect the battery.

20. The method as claimed in claim 18, further comprising:
reconnecting the battery after the reset time period with the battery protection unit.
